(19) United States
(12) Patent Application Publication
(10) Pub. No.: US 2009/0032773 A1
(43) Pub. Date: Feb. 5, 2009

(54) OXYGEN SCAVENGING COMPOSITION AND METHOD FOR MAKING SAME

(76) Inventors: Mark Andrew Horsham, New South Wales (AU); Andrew David Scully, Victoria (AU); James Keith Gerard Murphy, New South Wales (AU); Ross Anthony Santangelo, New South Wales (AU); Michael McNally, New South Wales (AU)

Correspondence Address: MCDERMOTT WILL & EMERY LLP, 600 13TH STREET, N.W., WASHINGTON, DC, 20005-3096, US

(21) Appl. No.: 11/630,982

(22) PCT Filed: Jun. 28, 2005
(86) PCT No.: PCT/AU05/00941

§ 371 Date: Jul. 30, 2008

(30) Foreign Application Priority Data
Jun. 28, 2004 (AU) 2004903522

(51) Int. Cl. C09K 15/08; C08K 5/08; C08K 5/053; C08K 5/06

(52) U.S. Cl. 252/404; 524/360; 524/396; 524/367

(57) ABSTRACT

The present invention provides polymeric compositions comprising an hydrogenated anthraquinone derivative and/or its enol/enolate tautomer. Methods of scavenging oxygen and preventing transmission of oxygen into a package using said compositions are also provided.

### FIELD OF THE INVENTION

This invention relates to a method of scavenging oxygen using polymeric compositions comprising hydrogenated anthraquinone derivatives, for use in, for example, food and beverage packaging to scavenge unwanted oxygen, which either remains within the package, or otherwise enters the package, following the packaging of the food or beverage. The hydrogenated anthraquinone derivative may also be incorporated into packaging materials, to scavenge oxygen which would otherwise have permeated through the packaging material to enter the inside of a package.

### BACKGROUND OF THE INVENTION

A wide variety of foods, beverages, pharmaceuticals and other materials are susceptible to significant loss in quality if they are exposed to oxygen during storage. The damage can arise from, for example, chemical oxidation of the product and/or microbial growth. In the field of packaging, such damage has been traditionally addressed by generating relatively low-oxygen atmospheres by vacuum packing and/or inert gas flushing. However, these methods are not generally applicable for various reasons. For example, the fast filling speeds commonly used in the food and beverage industries often prevent effective evacuation of, or thorough inert gas flushing of, food and beverage packages, and neither evacuation or inert gas flushing provides any residual capacity for removal of oxygen which may have desorbed from the package contents or entered the package by leakage or permeation. As a consequence, there has been much interest in the identification and development of chemical techniques for generating low-oxygen atmospheres.

In Australian Patent No. 672661 (the entire disclosure of which is incorporated herein by reference), the present applicant describes novel oxygen scavenging compositions comprising a source of labile hydrogen or electrons and a reducible organic compound, which may be readily activated or “triggered” (ie brought to its oxygen scavenging form) as required by exposure to, for example, ultraviolet (UV) light. The oxygen scavenging compositions, once activated, are capable of scavenging oxygen from an oxygenated atmosphere or liquid in substantial darkness for periods ranging from up to a few minutes or hours to over 100 days.

Most of the exemplified oxygen scavenging compositions described in Australian Patent No. 672661, are based on substituted anthraquinones as the reducible organic compound. Further examples of substituted anthraquinones suitable for use as the reducible organic compound in such oxygen scavenging compositions are disclosed in International Patent Application No. PCT/AU02/00341 (WO 02/076916) (the entire disclosure of which is hereby incorporated by reference).

There is a general need for alternative compounds and compositions useful for scavenging oxygen and, in particular, there is a need for compounds and compositions which do not necessarily require activation subsequent to formation into packaging materials in order to scavenge oxygen.

In addition, the substituted anthraquinones of the prior art discussed above tend to be coloured particularly in the reduced states. Compositions and packaging which contain such anthraquinones also tend to be coloured. For instance, films made using anthraquinone-based compositions can turn a deep yellow colour when the anthraquinone is reduced to activate the oxygen scavenging capacity. The coloured nature of the anthraquinone-based compositions is undesirable in many forms of packaging, particularly in the packaging of foodstuffs. It is therefore desirable, although not essential, that any alternative compounds and compositions for scavenging oxygen have, in general, substantially less colour than the prior art substituted anthraquinones.

### SUMMARY OF THE INVENTION

In a first aspect, the present invention provides a polymeric composition comprising a hydrogenated anthraquinone derivative and/or its enol/enolate tautomer or a substituted derivative thereof.

In a second aspect, the present invention provides a method of scavenging oxygen (particularly ground state molecular oxygen) in an atmosphere or liquid comprising the steps of:
(i) providing a polymeric composition according to the first aspect; and
(ii) exposing the atmosphere or liquid to the composition;
   such that at least a portion of the oxygen in the atmosphere or liquid is removed through oxidation of the hydrogenated anthraquinone derivative and/or its enol/enolate tautomer.

In a third aspect, the present invention provides a method of preventing the transmission of oxygen (particularly ground state molecular oxygen) through a package, said method comprising forming a package comprising or consisting of a packaging material, said packaging material comprising a polymeric composition according to the first aspect.

### BRIEF DESCRIPTION OF THE FIGURES

FIG. 1 shows a graph of oxygen transmission over time for EVOH films incorporating 2-Me-THAQ, and EVOH films not incorporating 2-Me-THAQ.

FIG. 2 shows a graph of oxygen transmission over time for MXD6 films incorporating THAQ, and MXD6 films not incorporating THAQ.

FIG. 3 shows UV-visible absorption spectra for THAQ in (a) isopropanol and (b) DMSO.

FIG. 4 shows a UV visible absorption spectrum for THAQ in MXD6 film.

FIG. 5 shows a UV-visible absorption spectrum for 2-Me-THAQ in EVOH film.

FIG. 6 shows the UV-visible absorption spectra for (a) THAQ (b) 2-Me-THAQ, and (e) 2-Me-HHAQ in PETG.

### DETAILED DESCRIPTION OF THE INVENTION

Hydrogenated anthraquinone derivatives, when in neat solid form, do not in general observably react with oxygen. The present applicant has surprisingly found that polymeric films formed by melt compression of hydrogenated anthraquinone derivatives with a range of different commercially available polymers, including ethylene-vinyl alcohol copolymers (EVOH) and polymers comprising metaxylene diamine and adipic acid (eg MXD-6 nylon), absorb oxygen. The films do not require activation subsequent to processing in order to scavenge oxygen.

As can be seen from the Examples, the absorption spectra of the polymeric films comprising THAQ indicates that a different chemical derivative is present in the film. The present applicant believes that this chemical derivative is the enol/enolate tautomer of THAQ. Without being bound by theory, it is believed that the presence of a base, present in residual amounts in some commercially available polymers, can catalyse the formation of the enol/enolate tautomer of the hydrogenated anthraquinone derivative and it is this species that absorbs (ie scavenges) the oxygen. Acid is also known to catalyse the tautomerisation of hydrogenated anthraquinones to the enol/enolate forms. It is also possible that the efficiency of the formation of the enol/enolate tautomer is related to the polarity of the polymer and/or the temperature involved in forming the polymeric composition.

Accordingly, in a first aspect, the present invention provides a polymeric composition comprising a hydrogenated anthraquinone derivative and/or its enol/enolate tautomer or a substituted derivative thereof.

The hydrogenated anthraquinone derivative and/or its enol/enolate tautomer is preferably selected from a compound of one of the formulae I, II and III:

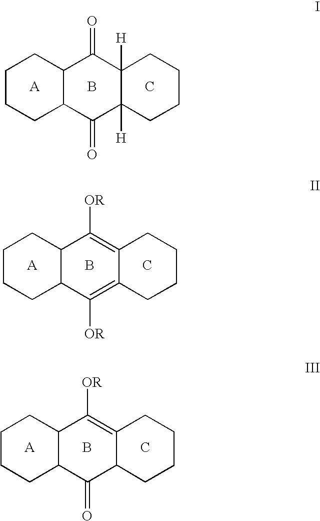

wherein each R is independently selected from hydrogen, a positively charged ion, an ester linkage and an ether linkage and wherein the bonds in rings A and C of the hydrogenated anthraquinone derivative and/or its enol/enolate tautomer can be independently saturated or unsaturated and the hydrogenated anthraquinone derivative and/or its enol/enolate tautomer is optionally substituted.

More preferably, the hydrogenated anthraquinone derivative and/or its enol/enolate tautomer is preferably selected from a compound of one of the formulae IV, V and VI:

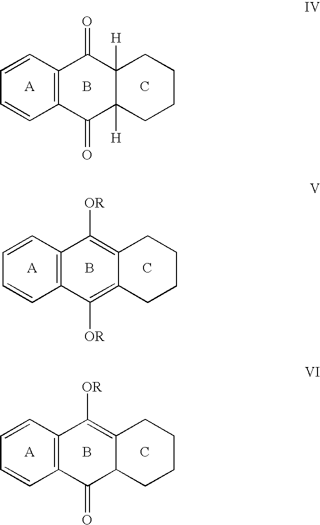

wherein each R is independently selected from hydrogen, a positively charged ion, an ester linkage and an ether linkage and wherein the bonds in ring C of the hydrogenated anthraquinone derivative and/or its enol/enolate tautomer can be independently saturated or unsaturated and the hydrogenated anthraquinone derivative and/or its enol/enolate tautomer is optionally substituted.

Preferably, the positively charged ion is Na⁺.

More preferably, the hydrogenated anthraquinone derivative comprises one or more compounds represented by the following formulae and substituted derivatives thereof:

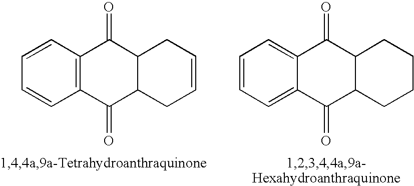

Particularly preferred hydrogenated anthraquinone derivatives are 1,4,4a,9a-Tetrahydroanthraquinone (THAQ) and substituted derivatives thereof. Preferred substituents are alkyl (particularly C₁₋₆ alkyl), halo, carboxylic acid, ester, anhydride, epoxy, hydroxy, and amine groups. An example of a substituted derivative is 2-methyl-1,4,4a,9a-Tetrahydroanthraquinone (2-Me-THAQ).

The present applicant expects, in the light of their discovery, that the direct incorporation into a polymeric composition of the enol/enolate form of a hydrogenated anthraquinone derivative would also result in a polymeric composition capable of scavenging oxygen.

Accordingly, in a preferred embodiment, the hydrogenated anthraquinone derivative and/or its enol/enolate derivative is an enol/enolate tautomer of a hydrogenated anthraquinone derivative or a substituted derivative thereof.

Preferably, the enol/enolate tautomer of a hydrogenated anthraquinone derivative is selected from a compound of one of the formulas VII and VIII and substituted derivatives thereof:

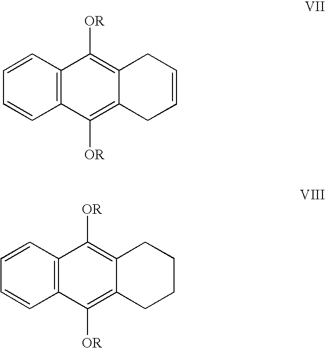

wherein each R is independently selected from hydrogen, a positively charged ion, an ester linkage and an ether linkage. More preferably, both of the R groups are hydrogen or ester linkages.

A preferred positively charged ion is Na⁺.

Preferably, the compound is of formula VII. More preferably, the enol/enolate tautomer of a hydrogenated anthraquinone derivative is the disodium salt of formula VII.

Preferably, the polymeric composition of the first aspect further comprises an acid or base. The amount of acid or base that may be present is preferably in the range of from 0.05% to 1.0% and more preferably in the range of 0.05% to 0.1% by weight of the polymeric composition.

The person skilled in the art would be aware of a number of acids that would be suitable to be incorporated in any particular polymer composition according to the present invention. Suitable acids include organic and inorganic acids such as hydrochloric acid, benzoic acid, p-toluenesulphonic acid, and acidic salts such as sodium chloride, potassium sulphate and ammonium chloride.

The person skilled in the art would be aware of a number of bases that would be suitable to be incorporated in any particular polymer composition of the present invention. Suitable bases include inorganic bases such as sodium hydroxide and basic salts such as metal salts of carboxylates, carbonates and bicarbonates.

Polymeric compositions of the first aspect may be in a solid, semi-solid (eg a gel) or liquid (eg a polymeric liquid such as an ink) form. They may therefore be applied as, or incorporated in, for example, bottle closure liners, inks, coatings, adhesives (eg polyurethanes), films, sheets, or layers in containers such as trays, bottles or blister packaging either alone or as laminations or co-extrusions. When used in films or layers, they may be blended with typical polymers or copolymers used for construction of films or layers such as those approved for food or pharmaceutical contact. Such films or layers may be produced by extrusion at temperatures between 50° C. and 350° C. depending upon chemical composition and molecular weight distribution.

The hydrogenated anthraquinone derivative may be blended into the polymeric composition. The polymeric composition may be formed from any suitable polymer or blend of polymers including polyamides, polyesters, polyethylenes and polyvinyl alcohols. Preferably, the polymer is EVOH, a polymer comprising metaxylene diamine and adipic acid units (eg MXD-6), or a polymer comprising terephthalic acid and ethylene glycol units (eg PET).

Alternatively, or additionally, the hydrogenated anthraquinone derivative itself may be in a polymerised form either as homopolymers or copolymers. Oligomer forms may also be suitable. Hydrogenated anthraquinone derivative-based monomers can be made, for example, by covalently bonding an ethylenically unsaturated group to ring A or C of the hydrogenated anthraquinone derivative. The hydrogenated anthraquinone derivative may also comprise groups, such as carboxylic acid, ester, anhydride, epoxy, hydroxy, and amine groups, capable of reaction with other polymerisable molecules and preformed polymers including reactions, involving the hydroxy groups of the enol tautomer. For instance, it is contemplated by the present applicant that an enol/enolate tautomer of formula VII3 can effectively act as a monomer in a copolymer by bridging through the two alcohol substituents via formation of ester or ether linkages.

The polymeric compositions of the first aspect are able to scavenge oxygen independently of the presence of a transition metal catalyst. Accordingly, in a preferred embodiment, the polymeric compositions do not comprise a transition metal catalyst.

Preferably, the hydrogenated anthraquinone derivatives and/or their enol/enolate tautomer for use in the method of the present invention are substantially colourless or show reduced colour relative to anthraquinones (particularly 2-ethylanthraquinone). Preferably, the hydrogenated anthraquinone derivative and/or its enol/enolate tautomer is selected such that it has a maximum absorbance in the visible spectrum (400 nm-700 nm) that is no more than half that of the reduced form of 2-ethylanthraquinone in EVOH under the same conditions.

In a second aspect, the present invention provides a method of scavenging oxygen (particularly ground state molecular oxygen) in an atmosphere or liquid comprising the steps of:
(i) providing a polymeric composition according to the first aspect; and
(ii) exposing the atmosphere or liquid to the composition;
   such that at least a portion of the oxygen in the atmosphere or liquid is removed through oxidation of the hydrogenated anthraquinone derivative and/or its enol/enolate tautomer.

The person skilled in the art would be aware that polymeric compositions of the first aspect may also be used as a chemical barrier to oxygen transmission through a packaging material. Thus, if a packaging material has finite oxygen permeability, the oxygen passing through it from the outside environment can be scavenged by the hydrogenated anthraquinone or enol/enolate tautomer thereof.

Accordingly, in a third aspect, the present invention provides a method of preventing the transmission of oxygen (particularly ground state molecular oxygen) through a package, said method comprising forming a package comprising or consisting of a packaging material, said packaging material comprising a polymeric composition according to the first aspect.

In order that the nature of the present invention may be more clearly understood, preferred forms thereof will now be described with reference to the following non-limiting examples.

### EXAMPLES

### Example 1

### Oxygen Scavenging by a Composition Comprising THAQ in EVOH

A composition was prepared by blending 1,4,4a,9a-Tetrahydroanthraquinone (THAQ) at a level of approximately 2% w/w into commercially available EVOH (32 mole % ethylene content) at 190° C. The composition was then compression moulded to form a film having a thickness of about 30 μm. The film was then quickly transferred into a foil multilayer bag, and this bag was then vacuum-sealed to form a flat package containing essentially no headspace. This foil-lined pouch allows essentially no ingress of oxygen from the atmosphere into the inside of the pouch. Air was then injected into the foil-lined pouch and the pouch stored at constant temperature. The oxygen content inside the pouch was determined using gas chromatography. The change in oxygen concentration in three pouches prepared in the manner described above, and stored at 40° C., is shown in Table 1. The films were substantially colourless and remained that way after exposure to oxygen.

TABLE 1

| Storage Time | Oxygen content inside pouch (%) | | |
|---|---|---|---|
| (days) | Pouch 1 | Pouch 2 | Pouch 3 |
| 0 | 20.9 | 20.9 | 20.9 |
| 1 | 20.8 | 20.8 | 20.8 |
| 2 | 20.8 | 20.7 | 20.7 |
| 5 | 20.6 | 20.6 | 20.4 |
| 16 | 20.2 | 20.0 | 19.7 |

### Example 2

### Oxygen Scavenging by a Composition Comprising 2-Me-THAQ in EVOH

The composition was prepared by blending 2-methyl-1,4,4a,9a-Tetrahydroanthraquinone (2-Me-THAQ) at a level or approximately 2% w/w into EVOH (44 mole % ethylene content) at 190° C. The composition was then compression moulded at 190° C. to form films having a thickness of about 50 μm. Bach film was then quickly transferred into a foil multilayer bag, and the bags were then vacuum-sealed to form flat packages containing essentially no headspace. This foil-lined pouch allows essentially no ingress of oxygen from the atmosphere into the inside of the pouch. A 4% O₂/96% N₂ gas mixture was then injected into each pouch. The pouches were then placed in a 120° C. oven to simulate the temperature of retort processing. The oxygen concentration of the headspace was determined using Gas Chromatography. The change in oxygen concentration in the pouches prepared in the manner described above is shown in Table 2. The films were substantially colourless and remained that way after exposure to oxygen.

TABLE 2

| Storage | | | | | | |
|---|---|---|---|---|---|---|
| Time | Oxygen content inside pouch (%) | | | | | |
| (minutes) | Pouch 1 | Pouch 2 | Pouch 3 | Pouch 4 | Pouch 5 | Pouch 6 |
| 0 | 4.0 | 43 | 3.7 | 3.8 | 3.9 | 4.7 |
| 30 | n/r* | n/r | 2.7 | n/r | 2.9 | 3.4 |
| 35 | 3.0 | 2.8 | n/r | n/r | n/r | n/r |
| 60 | 2.8 | n/r | n/r | n/r | 2.6 | 3.1 |
| 80 | n/r | n/r | 1.9 | 2.5 | n/r | n/r |

*n/r = no measurement made at these times

### Example 3

### Enhanced Barrier to Oxygen Permeation by a Composition Comprising 2-Me-THAQ in EVOH

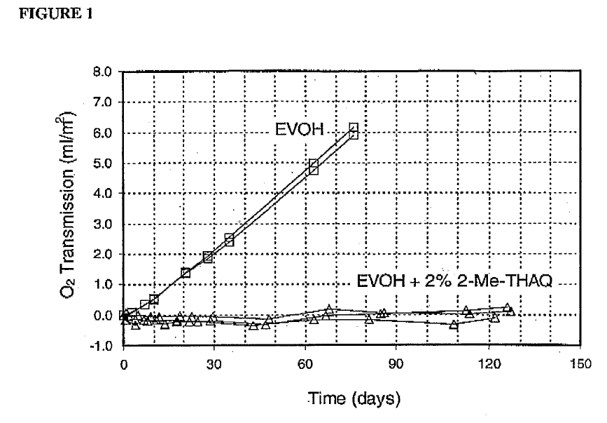

EVOH films (44 mole % ethylene content) containing approximately 2% w/w 2-Me-THAQ were prepared by melt-mixing and then melt-compression at 190° C. Film thicknesses were in the range 40-60 μm, and care was required to prepare films free from entrapped air bubbles which would otherwise interfere with the measurements. The oxygen transmission measurements were conducted using a technique involving sandwiching an oxygen-sensitive indicator film containing rubrene between two EVOH-based test films and sealing the three layers in a test cell. The test cell is then placed in an illuminated controlled temperature/humidity cabinet. The tests in this work were performed in air at 23° C. and 57% RH. The colour of the oxygen-sensitive indicator film decreases in the presence of oxygen and light, and this change is used to determine the permeation rate of oxygen through the test films. The light in the storage cabinet was filtered such that only the rubrene in the oxygen-sensitive indicator film received light during the course of experiments. The results of the experiments are shown in FIG. 1 and they clearly indicate that the incorporation of 2-Me-THAQ into the EVOH film substantially reduces the amount of oxygen transmitted through the film. The films were substantially colourless and remained that way after exposure to oxygen.

### Example 4

### Enhanced Barrier to Oxygen Permeation by a Composition Comprising THAQ m MXD6

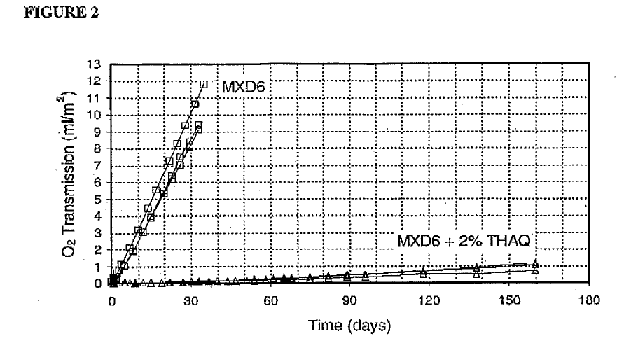

The amorphous MXD6 films containing approximately 2% w/w THAQ were prepared by melt-mixing and then melt-compression at 250° C. Film thicknesses were in the range 50-70 μm, and care was required to prepare films free from entrapped air bubbles which would otherwise interfere with the measurements. The oxygen transmission measurements were conducted using a technique involving sandwiching an oxygen-sensitive indicator film containing rubrene between two MXD6-based test films and sealing the three layers in a test cell. The test cell is then placed in an illuminated controlled temperature/humidity cabinet. The tests in this work were performed in air at 23° C. and 57% RH. The colour of the oxygen-sensitive indicator film decreases in the presence of oxygen and light, and this change is used to determine the permeation of oxygen through the test films. The light in the storage cabinet was filtered such that only the rubrene in the oxygen-sensitive indicator film received light during the course of experiments. FIG. 2 indicates that oxygen transmission through the MXD6 film is reduced substantially when the film comprises THAQ. The films were substantially colourless and remained that way after exposure to oxygen.

### Example 5

### Enolisation of THAQ in Solution

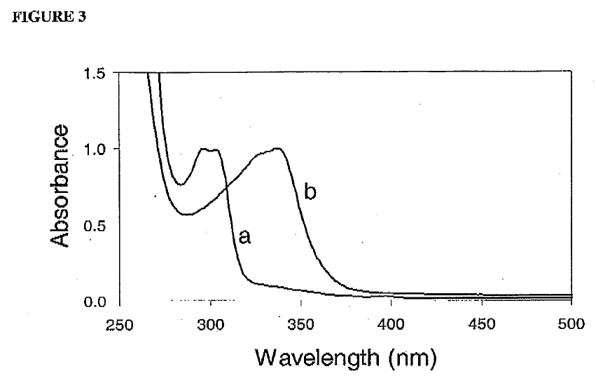

The absorption spectrum of a solution of THAQ dissolved in isopropanol (labelled “a”) and a solution of THAQ dissolved in DMSO (labelled “b”) is shown in FIG. 3. The difference between the absorption spectrum for THAQ in isopropanol and THAQ in DMSO indicates the formation of a different chemical species in DMSO, and the identity of this species was determined by ¹H nmr analysis to be the enol form of THAQ. Enolisation of THAQ was found not to occur in isopropanol solution at room temperature.

### Example 6

### Enolisation of THAQ in MXD6

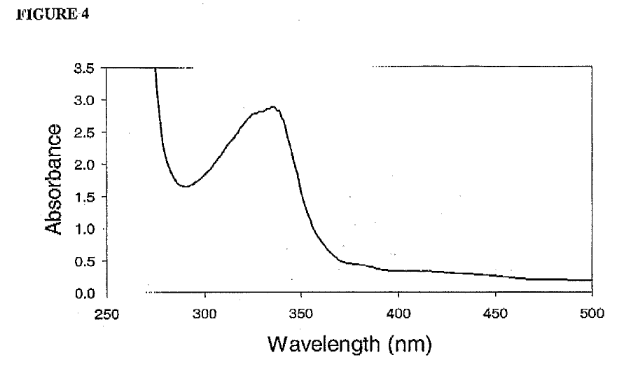

The composition was prepared by blending approximately 2% w/w of THAQ into commercially available MXD6, followed by compression moulding at 250° C. to form a film having a thickness of about 50 μm. The absorption spectrum of this film is shown in FIG. 4. The difference between the absorption spectrum of THAQ in isopropanol (see FIG. 3, spectrum “a”) and THAQ in MXD6 indicates the formation of a different chemical species in the MXD6, and this new species is assigned to the enol form of THAQ due to the very close similarity to the absorption spectrum of the enol tautomer in DMSO shown in FIG. 3, spectrum “b”.

### Example 7

### Enolisation of 2-Me-THAQ in EVOH

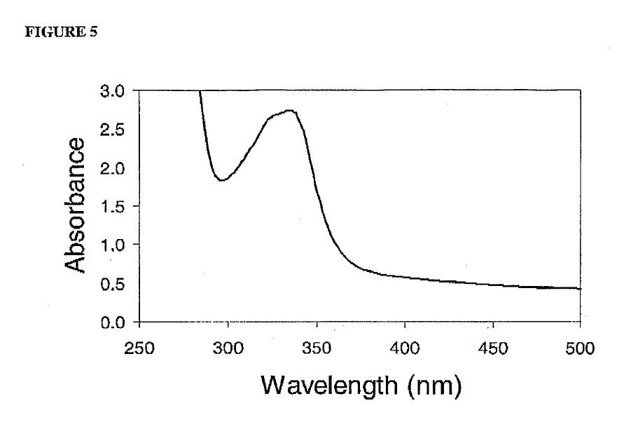

A composition was prepared by blending 2-Me-THAQ at a level of approximately 1% w/w into commercially available EVOH (44 mole % ethylene content) at 190° C. The composition was then compression moulded to form a film having a thickness of about 75 μm. The absorption spectrum of this film is shown in FIG. 5. The difference between the absorption spectrum of THAQ in isopropanol (sec FIG. 3, spectrum “a”) and 2-Me-THAQ in EVOH indicates the formation of a different chemical species in the EVOH, and this new species is assigned to the enol form of 2-MeTHAQ due to the very close similarity to the absorption spectrum of the enol tautomer of THAQ in DMSO shown in FIG. 3, spectrum “b”.

### Example 8

### Enolisation of Hydrogenated Anthraquinone Derivatives in PETG

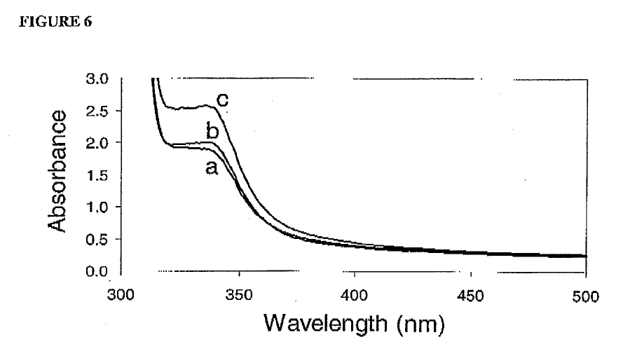

Compositions were prepared by blending THAQ, 2-Me-THAQ and 2-Me-1,2,3,4,4a,9a-Hexahydroanthraquinone (2-Me-HHAQ) at a level of approximately 1% w/w into commercially available PETG at 190° C. The compositions were then compression moulded to form films having a thickness of about 110 μm. The absorption spectra of these films are shown in FIG. 6. The difference between the absorption spectrum of THAQ in isopropanol (see FIG. 3, spectrum “a”) and these hydrogenated anthraquinone derivatives in PETG indicates the formation of a different chemical species in the PETG, and this new species is assigned to the enol forms of the hydrogenated anthraquinone derivatives due to the close similarity to the absorption spectrum of the enol tautomer of THAQ in DMSO shown in FIG. 3, spectrum “b”.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

All publications mentioned in this specification are herein incorporated by reference. Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia or elsewhere before the priority date of each claim of this application.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A polymeric composition comprising an hydrogenated anthraquinone derivative and/or its enol/enolate tautomer or a substituted derivative thereof.

2. A polymeric composition according to claim 1 wherein the hydrogenated anthraquinone derivative and/or its enol/enolate tautomer is preferably selected from a compound of one of the formulae I, II and III: 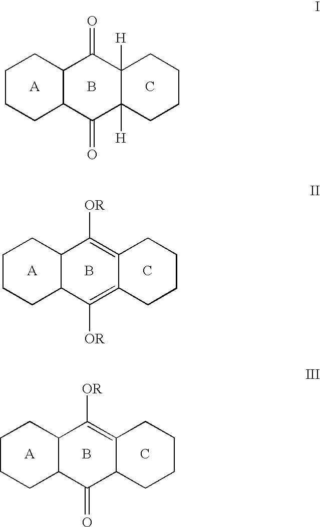
wherein each R is independently selected from hydrogen, a positively charged ion, an ester linkage and an ether linkage and wherein the bonds in rings A and C of the hydrogenated anthraquinone derivative and/or its enol/enolate tautomer can be independently saturated or unsaturated and the hydrogenated anthraquinone derivative and/or its enol/enolate tautomer is optionally substituted.

3. A polymeric composition according to claim 2 wherein the hydrogenated anthraquinone derivative and/or its enol/enolate tautomer is preferably selected from a compound of one of the formulae IV, V and VI: 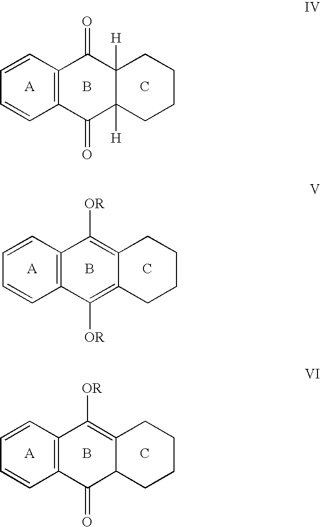
wherein each R is independently selected from hydrogen, a positively charged ion, an ester linkage and an ether linkage and wherein the bonds in ring C of the hydrogenated anthraquinone derivative and/or its enol/enolate tautomer can be independently saturated or unsaturated and the hydrogenated anthraquinone derivative and/or its enol/enolate tautomer is optionally substituted.

4. A polymeric composition according to any one of claims 1 to 3 wherein the hydrogenated anthraquinone derivative comprises one or more compounds represented by the following formulae and substituted derivatives thereof:

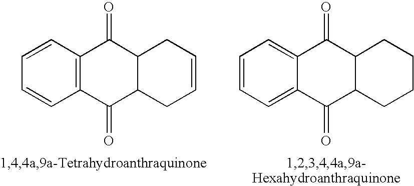

5. A polymeric composition according to claim 4 wherein the hydrogenated anthraquinone derivative is 1,4,4a,9a-Tetrahydroanthraquinone (THAQ) or a substituted derivative thereof.

6. A polymeric composition according to any one of claims 1 to 4 wherein the hydrogenated anthraquinone derivative and/or its enol/enolate derivative is an enol/enolate tautomer of a hydrogenated anthraquinone derivative or a substituted derivative thereof.

7. A polymeric composition according to claim 6 wherein the enol/enolate tautomer of a hydrogenated anthraquinone derivative is selected from a compound of one of the formulas VII and VIII and substituted derivatives thereof: 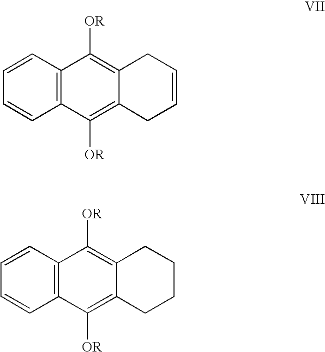
wherein each R is independently selected from hydrogen, a positively charged ion, an ester linkage and an ether linkage.

8. A polymeric composition according to claim 7 wherein the enol/enolate tautomer of a hydrogenated anthraquinone derivative is a compound of formula VII or a substituted derivative thereof.

9. A polymeric composition according to claim 8 wherein the compound of formula VII is the disodium salt of formula VII.

10. A polymeric composition according to any one of claims 1 to 9 further comprising an acid or base.

11. A polymeric composition according to claim 10 wherein the amount of acid or base present is in the range of from 0.05% to 1.0% by weight of the polymeric composition.

12. A polymeric composition according to claim 11 wherein the amount of acid or base present is in the range of 0.05% to 0,1% by weight of the polymeric composition.

13. A polymeric composition according to any one of claims 10 to 12 wherein the acid is selected from the group consisting of hydrochloric acid, benzoic acid, p-toluenesulphonic acid, sodium chloride, potassium sulphate and ammonium chloride.

14. A polymeric composition according to any one of claims 10 to 12 wherein the base is selected from sodium hydroxide and metal salts of carboxylates, carbonates and bicarbonates.

15. A polymeric composition according to any one of claims 1 to 14 wherein the polymeric composition comprises EVOH, polyamide, polyester, polyethylene, polyvinyl alcohol, and blends thereof.

16. A polymeric composition according to any one of claims 1 to 15 wherein the polymeric composition comprises EVOH, a polymer comprising metaxylene diamine and adipic acid units, or a polymer comprising terephthalic acid and ethylene glycol units.

17. A polymeric composition according to any one of claims 1 to 16 wherein the polymeric composition does not comprise a transition metal catalyst.

18. A packaging material comprising a polymeric composition according to any one of claims 1 to 17.

19. A method of scavenging oxygen in an atmosphere or liquid comprising the steps of:
(i) providing a polymeric composition according to any one of claims 1 to 17; and
(ii) exposing the atmosphere or liquid to the composition;
such that at least a portion of the oxygen in the atmosphere or liquid is removed through oxidation of the hydrogenated anthraquinone derivative and/or its enol/enolate tautomer.

20. A method of preventing the transmission of oxygen through a package, said method comprising forming a package comprising or consisting of a packaging material, said packaging material comprising a polymeric composition according to any one of claims 1 to 17.
